(19) United States
(12) Patent Application Publication
(10) Pub. No.: US 2024/0283584 A1
(43) Pub. Date: Aug. 22, 2024

(54) Methods for PRS Bandwidth Aggregation for Downlink Positioning

(71) Applicant: Apple Inc., Cupertino, CA (US)

(72) Inventors: Oghenekome Oteri, San Diego, CA (US); Hong He, Cupertino, CA (US); Seyed Ali Akbar Fakoorian, San Diego, CA (US); Dawei Zhang, Saratoga, CA (US); Wei Zeng, San Diego, CA (US); Haitong Sun, Cupertino, CA (US)

(21) Appl. No.: 18/481,051

(22) Filed: Oct. 4, 2023

Related U.S. Application Data
(60) Provisional application No. 63/485,511, filed on Feb. 16, 2023.

(51) Int. Cl. H04L 5/00; H04B 17/327; H04W 56/00; H04W 64/00

(52) U.S. Cl. CPC H04L 5/001; H04B 17/327; H04L 5/0048; H04W 56/005; H04W 64/003

(57) ABSTRACT

Apparatuses, systems, and methods for receiving and utilizing positioning reference signals (PRSs) with bandwidth aggregation, e.g., in 5G NR systems and beyond. A UE may adjust its measurement and timing procedures in various ways to accommodate PRS bandwidth aggregation across multiple positioning frequency layers and multiple component carriers. For example, various parameters and procedures may be adjusted to reduce power imbalance between component carriers, to accommodate measurement of the aggregated bandwidth, to allow increased measurement gap for receiving PRS from neighbor cells, to provide assistance information reporting impairment introduced by the PRS bandwidth aggregation, etc.

### PRIORITY INFORMATION

This application claims priority to U.S. provisional patent application Ser. No. 63/485,511, entitled “Methods for PRS Bandwidth Aggregation for Downlink Positioning,” filed Feb. 16, 2023, which is hereby incorporated by reference in its entirety as though fully and completely set forth herein.

### FIELD

The invention relates to wireless communications, and more particularly to apparatuses, systems, and methods for positioning reference signals (PRSs) with bandwidth aggregation, e.g., in cellular systems, such as LTE systems, 5G NR systems, and beyond.

### DESCRIPTION OF THE RELATED ART

Wireless communication systems are rapidly growing in usage. In recent years, wireless devices such as smart phones, wearable devices, or accessory devices), and tablet computers have become increasingly sophisticated. In addition to supporting telephone calls, many mobile devices now provide access to the internet, email, text messaging, and navigation using the global positioning system (GPS), and are capable of operating sophisticated applications that utilize these functionalities.

Long Term Evolution (LTE) is currently the technology of choice for the majority of wireless network operators worldwide, providing mobile broadband data and high-speed Internet access to their subscriber base. LTE was first proposed in 2004 and was first standardized in 2008. Since then, as usage of wireless communication systems has expanded exponentially, demand has risen for wireless network operators to support a higher capacity for a higher density of mobile broadband users. Thus, in 2015 study of a new radio access technology began and, in 2017, a first release of Fifth Generation New Radio (5G NR) was standardized.

5G-NR, also simply referred to as NR, provides, as compared to LTE, a higher capacity for a higher density of mobile broadband users, while also supporting device-to-device, ultra-reliable, and massive machine type communications with lower latency and/or lower battery consumption. Further, NR may allow for more flexible UE scheduling as compared to current LTE. Consequently, efforts are being made in ongoing developments of 5G-NR to take advantage of higher throughputs possible at higher frequencies.

### SUMMARY

Embodiments relate to wireless communications, and more particularly to apparatuses, systems, and methods for positioning reference signals (PRSs) with bandwidth aggregation, e.g., in 5G NR systems and beyond.

A method is described, which may be performed by a user equipment (UE) or one or more components thereof. The UE may determine that bandwidth aggregation is enabled for a plurality of positioning reference signal (PRS) resources across a plurality of positioning frequency layers (PFLs), and may receive, from a base station, the plurality of PRS resources.

The UE may then determine a first set of reference signal receive power (RSRP) measurements of at least a first subset of the plurality of PRS resources, the first subset including PRS resources from more than one PFL of the plurality of PFLs and provide to the base station, on each component carrier (CC) of a plurality of CCs, a report of the first set of RSRP measurements.

In some scenarios, the UE may also determine a second set of RSRP measurements of a second subset of the plurality of PRS resources, the PRS resources of the second subset belonging to a single PRS resource set, and provide to the base station, on a single CC of the plurality of CCs, a report of second set of RSRP measurements.

In some scenarios, the UE may determine a set of reference signal received path power (RSRPP) measurements for the first detected path of at least a third subset of the plurality of PRS resources, the third subset including PRS resources from more than one PFL of the plurality of PFLs. The UE may then provide to the base station a report of the set of RSRP measurements.

In some scenarios, the UE may determine a set of receive-transmit time difference measurements of at least a third subset of the plurality of PRS resources, the third subset including PRS resources from more than one PFL of the plurality of PFLs. The UE may then provide to the base station, a report of the set of receive-transmit time difference measurements.

In some scenarios, each CC of the plurality of CCs may contain a subset of the plurality of PRS resources.

In some scenarios, the PRS resources may have a higher priority level than a synchronization signal block (SSB).

In some scenarios, the PRS resources may be non-contiguous.

Apparatuses and computer-readable memory media are also disclosed for implementing any of the preceding methods.

The techniques described herein may be implemented in and/or used with a number of different types of devices, including but not limited to unmanned aerial vehicles (UAVs), unmanned aerial controllers (UACs), a UTM server, base stations, access points, cellular phones, tablet computers, wearable computing devices, portable media players, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings, in which:

FIG. 1A illustrates an example wireless communication system according to some embodiments.

FIG. 1B illustrates an example of a base station and an access point in communication with a user equipment (UE) device, according to some embodiments.

FIG. 2 illustrates an example block diagram of a base station, according to some embodiments.

FIG. 3 illustrates an example block diagram of a server according to some embodiments.

FIG. 4 illustrates an example block diagram of a UE according to some embodiments.

FIG. 5 illustrates an example block diagram of cellular communication circuitry, according to some embodiments.

FIG. 6A illustrates an example of a 5G network architecture that incorporates both 3GPP (e.g., cellular) and non-3GPP (e.g., non-cellular) access to the 5G CN, according to some embodiments.

FIG. 6B illustrates an example of a 5G network architecture that incorporates both dual 3GPP (e.g., LTE and 5G NR) access and non-3GPP access to the 5G CN, according to some embodiments.

FIG. 7 illustrates an example of a baseband processor architecture for a UE, according to some embodiments.

FIGS. 8A, 8B, and 8C illustrate scenarios in which three component carriers are configured to carry aggregated PRS resources, wherein the PRS resources are not received on one of the carriers, according to some embodiments.

FIGS. 9A, 9B, and 9C illustrate examples of measurement gaps adjusted to accommodate PRS bandwidth aggregation, according to some embodiments.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present disclosure. Definitions of the most prominently used acronyms that may appear throughout the present disclosure are provided below:
3GPP: Third Generation Partnership Project
UE: User Equipment
RF: Radio Frequency
DL: Downlink
UL: Uplink
LTE: Long Term Evolution
NR: New Radio
5GS: 5G System
5GMM: 5GS Mobility Management
5GC/5GCN: 5G Core Network
IE: Information Element
CE: Control Element
MAC: Medium Access Control
SSB: Synchronization Signal Block
CSI: Channel State Information
CSI-RS: Channel State Information Reference Signal
CMR: Channel Measurement Resource
PDCCH: Physical Downlink Control Channel
PDSCH: Physical Downlink Shared Channel
RRC: Radio Resource Control
RRM: Radio Resource Management
CORESET: Control Resource Set
TCI: Transmission Configuration Indicator
DCI: Downlink Control Indicator
NPN: Non-Public Network
SNPN: Standalone NPN
CAG: Closed Access Group
SON: Self-Organizing Network
PRS: Positioning Reference Signal
PFL: Positioning Frequency Layer
RSTD: Reference Signal Time Difference
RTOA: Relative Time of Arrival
CC: Component Carrier
RSRP: Reference Signal Received Power
LPP: LTE Positioning Protocol

### Terms

The following is a glossary of terms used in this disclosure:

Memory Medium—Any of various types of non-transitory memory devices or storage devices. The term “memory medium” is intended to include an installation medium, e.g., a CD-ROM, floppy disks, or tape device; a computer system memory or random-access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems devices which are mobile or portable and which performs wireless communications. Examples of UE devices include mobile telephones or smart phones (e.g., iPhone™, Android™_based phones), portable gaming devices (e.g., Nintendo DS™, PlayStation Portable™, Gameboy Advance™, iPhone™), laptops, wearable devices (e.g., smart watch, smart glasses), PDAs, portable Internet devices, music players, data storage devices, other handheld devices, unmanned aerial vehicles (UAVs) (e.g., drones), UAV controllers (UACs), and so forth. In general, the term “UE” or “UE device” can be broadly defined to encompass any electronic, computing, and/or telecommunications device (or combination of devices) which is easily transported by a user and capable of wireless communication.

Base Station—The term “Base Station” has the full breadth of its ordinary meaning, and at least includes a wireless communication station installed at a fixed location and used to communicate as part of a wireless telephone system or radio system.

Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, LTE may support scalable channel bandwidths from 1.4 MHz to 20 MHz. In contrast, WLAN channels may be 22 MHz wide while Bluetooth channels may be 1 Mhz wide. Other protocols and standards may include different definitions of channels. Furthermore, some standards may define and use multiple types of channels, e.g., different channels for uplink or downlink and/or different channels for different uses such as data, control information, etc.

Band—The term “band” has the full breadth of its ordinary meaning, and at least includes a section of spectrum (e.g., radio frequency spectrum) in which channels are used or set aside for the same purpose.

Wi-Fi—The term “Wi-Fi” (or WiFi) has the full breadth of its ordinary meaning, and at least includes a wireless communication network or RAT that is serviced by wireless LAN (WLAN) access points, and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.

3GPP Access—refers to accesses (e.g., radio access technologies) that are specified by 3GPP standards. These accesses include, but are not limited to, GSM/GPRS, LTE, LTE-A, and/or 5G NR. In general, 3GPP access refers to various types of cellular access technologies.

Non-3GPP Access—refers any accesses (e.g., radio access technologies) that are not specified by 3GPP standards. These accesses include, but are not limited to, WiMAX, CDMA2000, Wi-Fi, WLAN, and/or fixed networks. Non-3GPP accesses may be split into two categories, “trusted” and “untrusted”: Trusted non-3GPP accesses can interact directly with an evolved packet core (EPC) and/or a 5G core (5GC) whereas untrusted non-3GPP accesses interwork with the EPC/5GC via a network entity, such as an Evolved Packet Data Gateway and/or a 5G NR gateway. In general, non-3GPP access refers to various types on non-cellular access technologies.

Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Approximately—refers to a value that is almost correct or exact. For example, approximately may refer to a value that is within 1 to 10 percent of the exact (or desired) value. It should be noted, however, that the actual threshold value (or tolerance) may be application dependent. For example, in some embodiments, “approximately” may mean within 0.1% of some specified or desired value, while in various other embodiments, the threshold may be, for example, 2%, 3%, 5%, and so forth, as desired or as required by the particular application.

Concurrent—refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

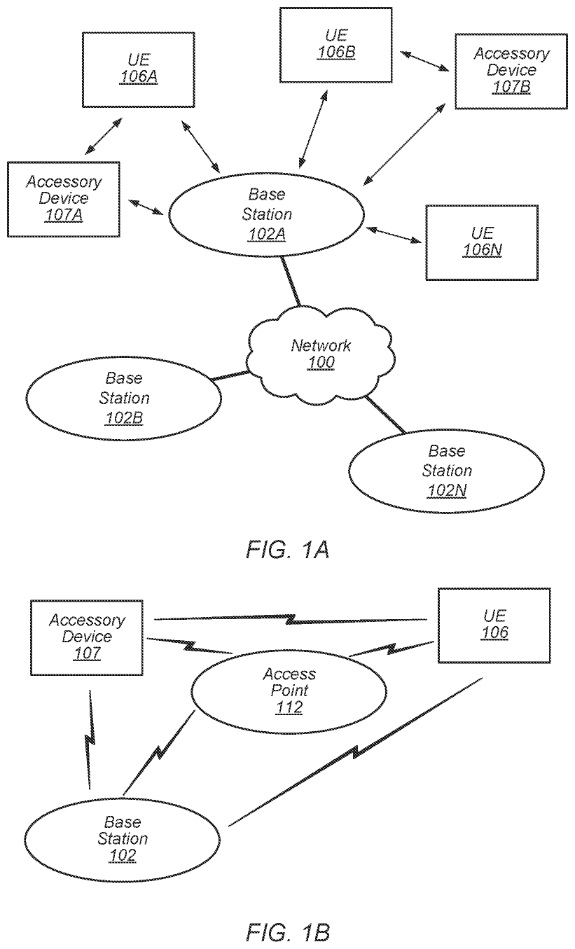

### FIGS. 1A and 1B: Communication Systems

FIG. 1A illustrates a simplified example wireless communication system, according to some embodiments. It is noted that the system of FIG. 1A is merely one example of a possible system, and that features of this disclosure may be implemented in any of various systems, as desired.

As shown, the example wireless communication system includes a base station 102A which communicates over a transmission medium with one or more wireless devices, such as user devices 106A, 106B, etc., through 106N, as well as accessory devices, such as user devices 107A, 107B. Each of the user devices may be referred to herein as a “user equipment” (UE). Thus, the user devices 106 and 107 are referred to as UEs or UE devices.

The base station (BS) 102A may be a base transceiver station (BTS) or cell site (a “cellular base station”) and may include hardware that enables wireless communication with the UEs 106A through 106N as well as UEs 107A and 107B.

The communication area (or coverage area) of the base station may be referred to as a “cell.” The base station 102A and the UEs 106/107 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA2000 (e.g., 1×RTT, 1×EV-DO, HRPD, eHRPD), etc. Note that if the base station 102A is implemented in the context of LTE, it may alternately be referred to as an ‘eNodeB’ or ‘eNB’. Note that if the base station 102A is implemented in the context of 5G NR, it may alternately be referred to as ‘gNodeB’ or ‘gNB’.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106/107 with various telecommunication capabilities, such as voice, SMS and/or data services.

Base station 102A and other similar base stations (such as base stations 102B . . . 102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106/107 as illustrated in FIG. 1, each UE 106/107 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1 might be macro cells, while base station 102N might be a micro cell. Other configurations are also possible.

In some embodiments, base station 102A may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB cell may include one or more transition and reception points (TRPs). In addition, a UE capable of operating according to 5G NR may be connected to one or more TRPs within one or more gNBs.

Note that a UE 106/107 may be capable of communicating using multiple wireless communication standards. For example, the UE 106/107 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR, HSPA, 3GPP2 CDMA2000 (e.g., 1×RTT, 1×EV-DO, HRPD, eHRPD), etc.). The UE 106/107 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

Note that accessory devices 107A/B may include cellular communication capability and hence are able to directly communicate with cellular base station 102A via a cellular RAT. However, since the accessory devices 107A/B are possibly one or more of communication, output power, and/or battery limited, the accessory devices 107A/B may in some instances selectively utilize the UEs 106A/B as a proxy for communication purposes with the base station 102A and hence to the network 100. In other words, the accessory devices 107A/B may selectively use the cellular communication capabilities of its companion device (e.g., UEs 106A/B) to conduct cellular communications. The limitation on communication abilities of the accessory devices 107A/B may be permanent, e.g., due to limitations in output power or the RATs supported, or temporary, e.g., due to conditions such as current battery status, inability to access a network, or poor reception.

FIG. 1B illustrates user equipment 106 (e.g., one of the devices 106A through 106N) and accessory device (or user equipment) 107 (e.g., one of the devices 107A or 107B) in communication with a base station 102 and an access point 112 as well as one another, according to some embodiments. The UEs 106/107 may be devices with both cellular communication capability and non-cellular communication capability (e.g., Bluetooth, Wi-Fi, and so forth) such as a mobile phone, a wearable device, a hand-held device, a computer or a tablet, or virtually any type of wireless device. The accessory device 107 may be a wearable device such as a smart watch. The accessory device 107 may comprise cellular communication capability and be capable of directly communicating with the base station 102 as shown. Note that when the accessory device 107 is configured to directly communicate with the base station, the accessory device may be said to be in “autonomous mode.” In addition, the accessory device 107 may also be capable of communicating with another device (e.g., UE 106), referred to as a proxy device, intermediate device, or companion device, using a short-range communications protocol; for example, the accessory device 107 may according to some embodiments be “paired” with the UE 106, which may include establishing a communication channel and/or a trusted communication relationship with the UE 106. Under some circumstances, the accessory device 107 may use the cellular functionality of this proxy device for communicating cellular voice and/or data with the base station 102. In other words, the accessory device 107 may provide voice and/or data packets intended for the base station 102 over the short-range link to the UE 106, and the UE 106 may use its cellular functionality to transmit (or relay) this voice and/or data to the base station on behalf of the accessory device 107. Similarly, the voice and/or data packets transmitted by the base station and intended for the accessory device 107 may be received by the cellular functionality of the UE 106 and then may be relayed over the short-range link to the accessory device. As noted above, the UE 106 may be a mobile phone, a tablet, or any other type of hand-held device, a media player, a computer, a laptop or virtually any type of wireless device. Note that when the accessory device 107 is configured to indirectly communicate with the base station 102 using the cellular functionality of an intermediate or proxy device, the accessory device may be said to be in “relay mode.”

The UE 106/107 may include a processor that is configured to execute program instructions stored in memory. The UE 106/107 may perform any of the method embodiments described herein by executing such stored instructions. Alternatively, or in addition, the UE 106/107 may include a programmable hardware element such as an FPGA (field-programmable gate array) that is configured to perform any of the method embodiments described herein, or any portion of any of the method embodiments described herein.

The UE 106/107 may include one or more antennas for communicating using one or more wireless communication protocols or technologies. In some embodiments, the UE 106 may be configured to communicate using, for example, CDMA2000 (1×RTT/1×EV-DO/HRPD/eHRPD), LTE/LTE-Advanced, or 5G NR using a single shared radio and/or GSM, LTE, LTE-Advanced, or 5G NR using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106/107 may share one or more parts of a receive and/or transmit chain between multiple wireless communication technologies, such as those discussed above.

In some embodiments, the UE 106/107 may include separate transmit and/or receive chains (e.g., including separate antennas and other radio components) for each wireless communication protocol with which it is configured to communicate. As a further possibility, the UE 106/107 may include one or more radios which are shared between multiple wireless communication protocols, and one or more radios which are used exclusively by a single wireless communication protocol. For example, the UE 106/107 might include a shared radio for communicating using either of LTE or 5G NR (or LTE or 1×RTT or LTE or GSM), and separate radios for communicating using each of Wi-Fi and Bluetooth. Other configurations are also possible.

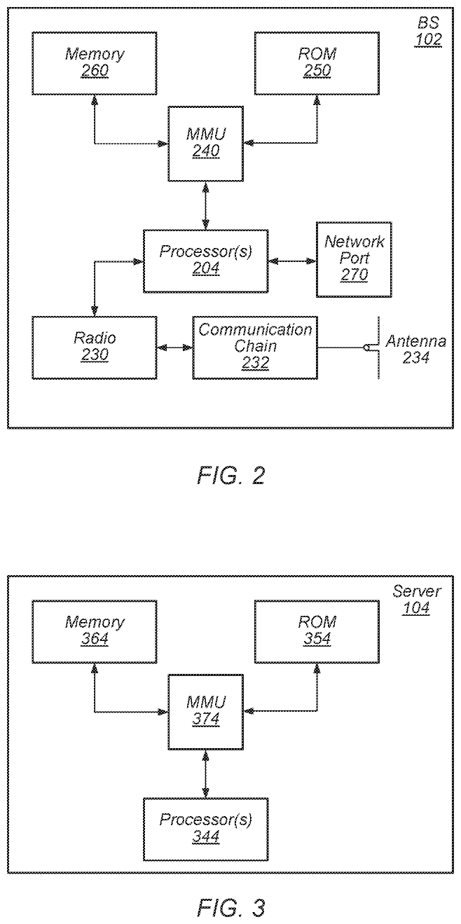

### FIG. 2: Block Diagram of a Base Station

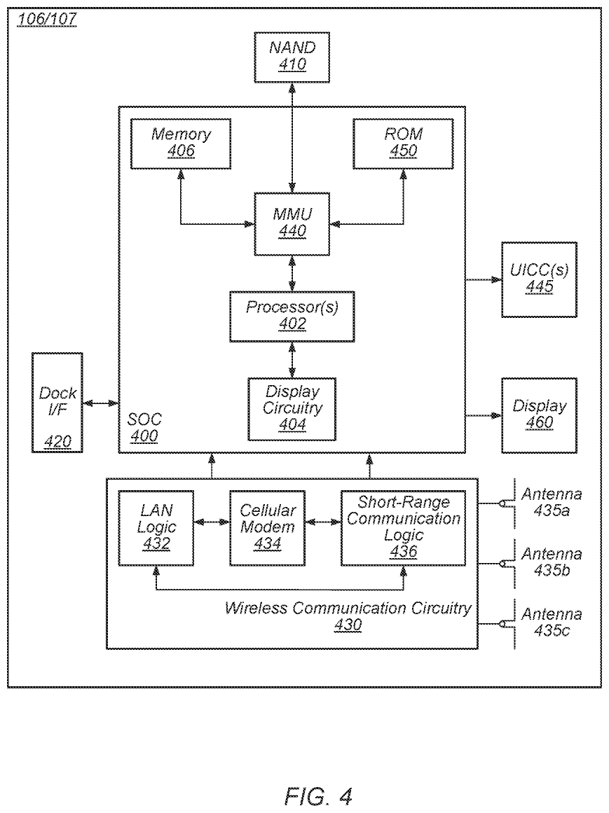

FIG. 2 illustrates an example block diagram of a base station 102, according to some embodiments. It is noted that the base station of FIG. 3 is merely one example of a possible base station. As shown, the base station 102 may include processor(s) 204 which may execute program instructions for the base station 102. The processor(s) 204 may also be coupled to memory management unit (MMU) 240, which may be configured to receive addresses from the processor(s) 204 and translate those addresses to locations in memory (e.g., memory 260 and read only memory (ROM) 250) or to other circuits or devices.

The base station 102 may include at least one network port 270. The network port 270 may be configured to couple to a telephone network and provide a plurality of devices, such as UE devices 106, access to the telephone network as described above in FIGS. 1 and 2.

The network port 270 (or an additional network port) may also or alternatively be configured to couple to a cellular network, e.g., a core network of a cellular service provider. The core network may provide mobility related services and/or other services to a plurality of devices, such as UE devices 106. In some cases, the network port 270 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 234, and possibly multiple antennas. The at least one antenna 234 may be configured to operate as a wireless transceiver and may be further configured to communicate with UE devices 106 via radio 230. The antenna 234 communicates with the radio 230 via communication chain 232. Communication chain 232 may be a receive chain, a transmit chain or both. The radio 230 may be configured to communicate via various wireless communication standards, including, but not limited to, 5G NR, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 204 of the base station 102 may be configured to implement or support implementation of part or all of the methods described herein, e.g., by executing program instructions stored on a memory medium (e.g., a non-transitory computer-readable memory medium). Alternatively, the processor 204 may be configured as a programmable hardware element, such as an FPGA (Field Programmable Gate Array), or as an ASIC (Application Specific Integrated Circuit), or a combination thereof. Alternatively (or in addition) the processor 204 of the BS 102, in conjunction with one or more of the other components 230, 232, 234, 240, 250, 260, 270 may be configured to implement or support implementation of part or all of the features described herein.

In addition, as described herein, processor(s) 204 may be comprised of one or more processing elements. In other words, one or more processing elements may be included in processor(s) 204. Thus, processor(s) 204 may include one or more integrated circuits (ICs) that are configured to perform the functions of processor(s) 204. In addition, each integrated circuit may include circuitry (e.g., first circuitry, second circuitry, etc.) configured to perform the functions of processor(s) 204.

Further, as described herein, radio 230 may be comprised of one or more processing elements. In other words, one or more processing elements may be included in radio 230. Thus, radio 230 may include one or more integrated circuits (ICs) that are configured to perform the functions of radio 230. In addition, each integrated circuit may include circuitry (e.g., first circuitry, second circuitry, etc.) configured to perform the functions of radio 230.

### FIG. 3: Block Diagram of a Server

FIG. 3 illustrates an example block diagram of a server 104, according to some embodiments. It is noted that the server of FIG. 3 is merely one example of a possible server. As shown, the server 104 may include processor(s) 344 which may execute program instructions for the server 104. The processor(s) 344 may also be coupled to memory management unit (MMU) 374, which may be configured to receive addresses from the processor(s) 344 and translate those addresses to locations in memory (e.g., memory 364 and read only memory (ROM) 354) or to other circuits or devices.

The server 104 may be configured to provide a plurality of devices, such as base station 102, UE devices 106, and/or UTM 108, access to network functions, e.g., as further described herein.

In some embodiments, the server 104 may be part of a radio access network, such as a 5G New Radio (5G NR) radio access network. In some embodiments, the server 104 may be connected to a legacy evolved packet core (EPC) network and/or to a NR core (NRC) network.

As described further subsequently herein, the server 104 may include hardware and software components for implementing or supporting implementation of features described herein. The processor 344 of the server 104 may be configured to implement or support implementation of part or all of the methods described herein, e.g., by executing program instructions stored on a memory medium (e.g., a non-transitory computer-readable memory medium). Alternatively, the processor 344 may be configured as a programmable hardware element, such as an FPGA (Field Programmable Gate Array), or as an ASIC (Application Specific Integrated Circuit), or a combination thereof. Alternatively (or in addition) the processor 344 of the server 104, in conjunction with one or more of the other components 354, 364, and/or 374 may be configured to implement or support implementation of part or all of the features described herein.

In addition, as described herein, processor(s) 344 may be comprised of one or more processing elements. In other words, one or more processing elements may be included in processor(s) 344. Thus, processor(s) 344 may include one or more integrated circuits (ICs) that are configured to perform the functions of processor(s) 344. In addition, each integrated circuit may include circuitry (e.g., first circuitry, second circuitry, etc.) configured to perform the functions of processor(s) 344.

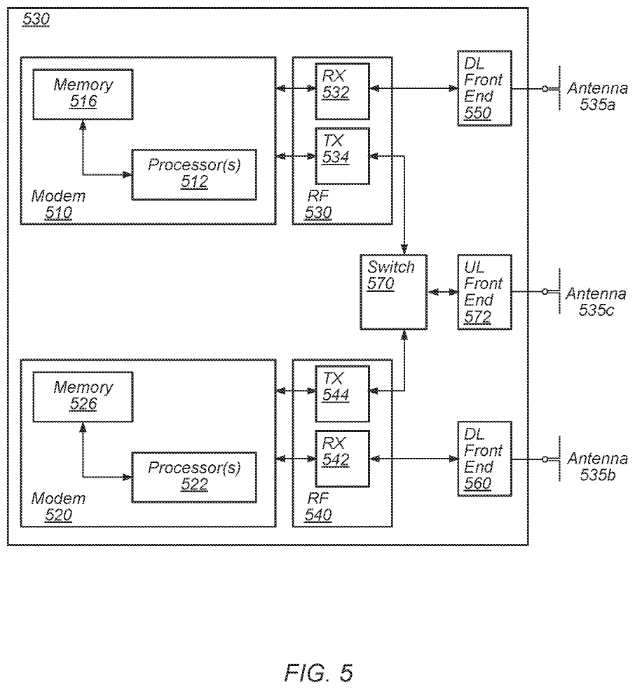

### FIG. 4: Block Diagram of a UE

FIG. 4 illustrates an example simplified block diagram of a communication device 106/107, according to some embodiments. It is noted that the block diagram of the communication device of FIG. 4 is only one example of a possible communication device. According to embodiments, communication device 106/107 may be a user equipment (UE) device, a mobile device or mobile station, a wireless device or wireless station, a desktop computer or computing device, a mobile computing device (e.g., a laptop, notebook, or portable computing device), a wearable device, a tablet, an unmanned aerial vehicle (UAV), a UAV controller (UAC) and/or a combination of devices, among other devices. As shown, the communication device 106/107 may include a set of components 400 configured to perform core functions. For example, this set of components may be implemented as a system on chip (SOC), which may include portions for various purposes. Alternatively, this set of components 400 may be implemented as separate components or groups of components for the various purposes. The set of components 400 may be coupled (e.g., communicatively; directly or indirectly) to various other circuits of the communication device 106.

For example, the communication device 106/107 may include various types of memory (e.g., including NAND flash 410), an input/output interface such as connector I/F 420 (e.g., for connecting to a computer system; dock; charging station; input devices, such as a microphone, camera, keyboard; output devices, such as speakers; etc.), the display 460, which may be integrated with or external to the communication device 106/107, and wireless communication circuitry 430. The wireless communication circuitry 430 may include a cellular modem 434 such as for 5G NR, LTE, GSM, etc., and short to medium range wireless communication logic 436 (e.g., Bluetooth™ and WLAN circuitry). In some embodiments, communication device 106/107 may include wired communication circuitry (not shown), such as a network interface card, e.g., for Ethernet.

The wireless communication circuitry 430 may couple (e.g., communicatively; directly or indirectly) to one or more antennas, such as antennas 435a, 435b, and 435c (e.g., 435a-c) as shown. The wireless communication circuitry 430 may include local area network (LAN) logic 432, the cellular modem 434, and/or short-range communication logic 436. The LAN logic 432 may be for enabling the UE device 106/107 to perform LAN communications, such as Wi-Fi communications on an 802.11 network, and/or other WLAN communications. The short-range communication logic 436 may be for enabling the UE device 106/107 to perform communications according to a short-range RAT, such as Bluetooth or UWB communications. In some scenarios, the cellular modem 434 may be a lower power cellular modem capable of performing cellular communication according to one or more cellular communication technologies.

In some embodiments, as further described below, cellular modem 434 may include dedicated receive chains (including and/or coupled to, e.g., communicatively; directly or indirectly. dedicated processors and/or radios) for multiple RATs (e.g., a first receive chain for LTE and a second receive chain for 5G NR). In addition, in some embodiments, cellular modem 434 may include a single transmit chain that may be switched between radios dedicated to specific RATs. For example, a first radio may be dedicated to a first RAT, e.g., LTE, and may be in communication with a dedicated receive chain and a transmit chain shared with an additional radio, e.g., a second radio that may be dedicated to a second RAT, e.g., 5G NR, and may be in communication with a dedicated receive chain and the shared transmit chain.

The communication device 106/107 may also include and/or be configured for use with one or more user interface elements. The user interface elements may include any of various elements, such as display 460 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106/107 may further include one or more smart cards 445 that include SIM (Subscriber Identity Module) functionality, such as one or more UICC(s) (Universal Integrated Circuit Card(s)) cards 445. Note that the term “SIM” or “SIM entity” is intended to include any of various types of SIM implementations or SIM functionality, such as the one or more UICC(s) cards 445, one or more eUICCs, one or more eSIMs, either removable or embedded, etc. In some embodiments, the UE 106/107 may include at least two SIMs. Each SIM may execute one or more SIM applications and/or otherwise implement SIM functionality. Thus, each SIM may be a single smart card that may be embedded, e.g., may be soldered onto a circuit board in the UE 106/107, or each SIM 410 may be implemented as a removable smart card. Thus, the SIM(s) may be one or more removable smart cards (such as UICC cards, which are sometimes referred to as “SIM cards”), and/or the SIMs 410 may be one or more embedded cards (such as embedded UICCs (eUICCs), which are sometimes referred to as “eSIMs” or “eSIM cards”). In some embodiments (such as when the SIM(s) include an eUICC), one or more of the SIM(s) may implement embedded SIM (eSIM) functionality; in such an embodiment, a single one of the SIM(s) may execute multiple SIM applications. Each of the SIMs may include components such as a processor and/or a memory; instructions for performing SIM/eSIM functionality may be stored in the memory and executed by the processor. In some embodiments, the UE 106/107 may include a combination of removable smart cards and fixed/non-removable smart cards (such as one or more eUICC cards that implement eSIM functionality), as desired. For example, the UE 106/107 may comprise two embedded SIMs, two removable SIMs, or a combination of one embedded SIMs and one removable SIMs. Various other SIM configurations are also contemplated.

As noted above, in some embodiments, the UE 106/107 may include two or more SIMs. The inclusion of two or more SIMs in the UE 106/107 may allow the UE 106/107 to support two different telephone numbers and may allow the UE 106/107 to communicate on corresponding two or more respective networks. For example, a first SIM may support a first RAT such as LTE, and a second SIM 410 support a second RAT such as 5G NR. Other implementations and RATs are of course possible. In some embodiments, when the UE 106/107 comprises two SIMs, the UE 106/107 may support Dual SIM Dual Active (DSDA) functionality. The DSDA functionality may allow the UE 106/107 to be simultaneously connected to two networks (and use two different RATs) at the same time, or to simultaneously maintain two connections supported by two different SIMs using the same or different RATs on the same or different networks. The DSDA functionality may also allow the UE 106/107 to simultaneously receive voice calls or data traffic on either phone number. In certain embodiments the voice call may be a packet switched communication. In other words, the voice call may be received using voice over LTE (VoLTE) technology and/or voice over NR (VoNR) technology. In some embodiments, the UE 106/107 may support Dual SIM Dual Standby (DSDS) functionality. The DSDS functionality may allow either of the two SIMs in the UE 106/107 to be on standby waiting for a voice call and/or data connection. In DSDS, when a call/data is established on one SIM, the other SIM is no longer active. In some embodiments, DSDx functionality (either DSDA or DSDS functionality) may be implemented with a single SIM (e.g., a eUICC) that executes multiple SIM applications for different carriers and/or RATs.

As shown, the SOC 400 may include processor(s) 402, which may execute program instructions for the communication device 106 and display circuitry 404, which may perform graphics processing and provide display signals to the display 460. The processor(s) 402 may also be coupled to memory management unit (MMU) 440, which may be configured to receive addresses from the processor(s) 402 and translate those addresses to locations in memory (e.g., memory 406, read only memory (ROM) 450, NAND flash memory 410) and/or to other circuits or devices, such as the display circuitry 404, short to medium range wireless communication circuitry 429, cellular communication circuitry 430, connector I/F 420, and/or display 460. The MMU 440 may be configured to perform memory protection and page table translation or set up. In some embodiments, the MMU 440 may be included as a portion of the processor(s) 402.

As noted above, the communication device 106 may be configured to communicate using wireless and/or wired communication circuitry. The communication device 106 may be configured to perform methods for positioning reference signals (PRSs) with aggregated bandwidth, e.g., in 5G NR systems and beyond, as further described herein.

As described herein, the communication device 106/107 may include hardware and software components for implementing the above features for a communication device 106/107 to communicate a scheduling profile for power savings to a network. The processor 402 of the communication device 106/107 may be configured to implement part or all of the features described herein, e.g., by executing program instructions stored on a memory medium (e.g., a non-transitory computer-readable memory medium). Alternatively (or in addition), processor 402 may be configured as a programmable hardware element, such as an FPGA (Field Programmable Gate Array), or as an ASIC (Application Specific Integrated Circuit). Alternatively (or in addition) the processor 402 of the communication device 106, in conjunction with one or more of the other components 400, 404, 406, 410, 420, 429, 430, 440, 445, 450, 460 may be configured to implement part or all of the features described herein.

In addition, as described herein, processor 402 may include one or more processing elements. Thus, processor 402 may include one or more integrated circuits (ICs) that are configured to perform the functions of processor 402. In addition, each integrated circuit may include circuitry (e.g., first circuitry, second circuitry, etc.) configured to perform the functions of processor(s) 402.

Further, as described herein, cellular communication circuitry 430 and short to medium range wireless communication circuitry 429 may each include one or more processing elements. In other words, one or more processing elements may be included in cellular communication circuitry 430 and, similarly, one or more processing elements may be included in short to medium range wireless communication circuitry 429. Thus, cellular communication circuitry 430 may include one or more integrated circuits (ICs) that are configured to perform the functions of cellular communication circuitry 430. In addition, each integrated circuit may include circuitry (e.g., first circuitry, second circuitry, etc.) configured to perform the functions of cellular communication circuitry 430. Similarly, the short to medium range wireless communication circuitry 429 may include one or more ICs that are configured to perform the functions of short to medium range wireless communication circuitry 429. In addition, each integrated circuit may include circuitry (e.g., first circuitry, second circuitry, etc.) configured to perform the functions of short to medium range wireless communication circuitry 429.

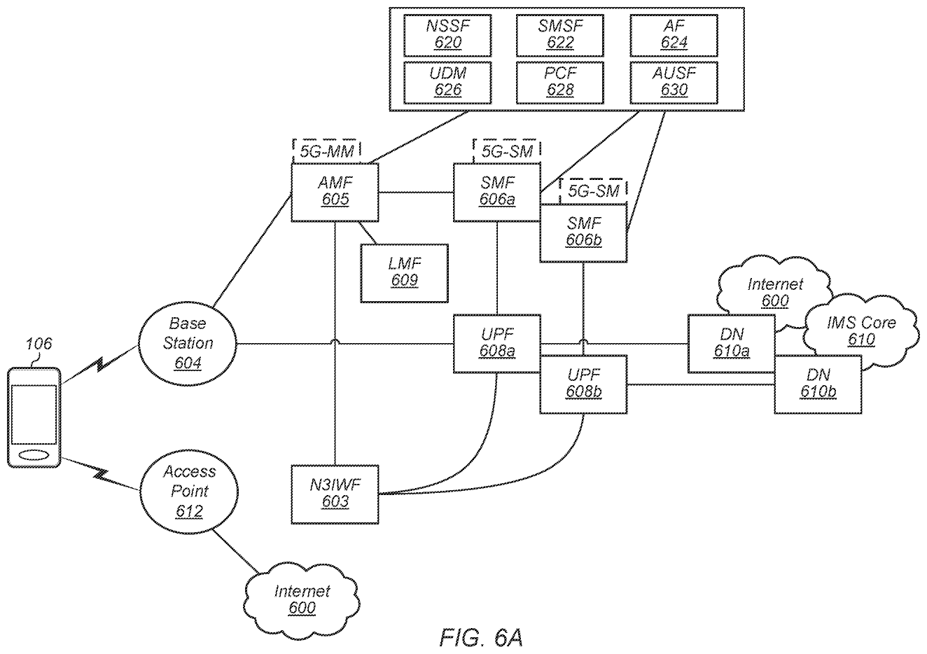

### FIG. 5: Block Diagram of Cellular Communication Circuitry

FIG. 5 illustrates an example simplified block diagram of cellular communication circuitry, according to some embodiments. It is noted that the block diagram of the cellular communication circuitry of FIG. 5 is only one example of a possible cellular communication circuit. According to embodiments, cellular communication circuitry 530, which may be cellular modem circuitry 434, may be included in a communication device, such as communication device 106/107 described above. As noted above, communication device 106/107 may be a user equipment (UE) device, a mobile device or mobile station, a wireless device or wireless station, a desktop computer or computing device, a mobile computing device (e.g., a laptop, notebook, or portable computing device), a tablet, a wearable device, and/or a combination of devices, among other devices.

The cellular communication circuitry 530 may couple (e.g., communicatively; directly or indirectly) to one or more antennas, such as antennas 535a-c (which may be antennas 435a-c of FIG. 4). In some embodiments, cellular communication circuitry 530 may include dedicated receive chains (including and/or coupled to, e.g., communicatively; directly or indirectly. dedicated processors and/or radios) for multiple RATs (e.g., a first receive chain for LTE and a second receive chain for 5G NR). For example, as shown in FIG. 5, cellular communication circuitry 530 may include a modem 510 and a modem 520. Modem 510 may be configured for communications according to a first RAT, e.g., such as LTE or LTE-A, and modem 520 may be configured for communications according to a second RAT, e.g., such as 5G NR.

As shown, modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some embodiments, receive circuitry 532 may be in communication with downlink (DL) front end 550, which may include circuitry for receiving radio signals via antenna 535a.

Similarly, modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some embodiments, receive circuitry 542 may be in communication with DL front end 560, which may include circuitry for receiving radio signals via antenna 535b.

In some embodiments, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 535c. Thus, when cellular communication circuitry 530 receives instructions to transmit according to the first RAT (e.g., as supported via modem 510), switch 570 may be switched to a first state that allows modem 510 to transmit signals according to the first RAT (e.g., via a transmit chain that includes transmit circuitry 534 and UL front end 572). Similarly, when cellular communication circuitry 530 receives instructions to transmit according to the second RAT (e.g., as supported via modem 520), switch 570 may be switched to a second state that allows modem 520 to transmit signals according to the second RAT (e.g., via a transmit chain that includes transmit circuitry 544 and UL front end 572).

In some embodiments, the cellular communication circuitry 530 may be configured to perform methods for positioning reference signals (PRSs) with aggregated bandwidth, e.g., in 5G NR systems and beyond, as further described herein.

As described herein, the modem 510 may include hardware and software components for implementing the above features or for time division multiplexing UL data for NSA NR operations, as well as the various other techniques described herein. The processors 512 may be configured to implement part or all of the features described herein, e.g., by executing program instructions stored on a memory medium (e.g., a non-transitory computer-readable memory medium). Alternatively (or in addition), processor 512 may be configured as a programmable hardware element, such as an FPGA (Field Programmable Gate Array), or as an ASIC (Application Specific Integrated Circuit). Alternatively (or in addition) the processor 512, in conjunction with one or more of the other components 530, 532, 534, 550, 570, 572, 535a-c may be configured to implement part or all of the features described herein.

In addition, as described herein, processors 512 may include one or more processing elements. Thus, processors 512 may include one or more integrated circuits (ICs) that are configured to perform the functions of processors 512. In addition, each integrated circuit may include circuitry (e.g., first circuitry, second circuitry, etc.) configured to perform the functions of processors 512.

As described herein, the modem 520 may include hardware and software components for implementing the above features for positioning reference signals (PRSs) with aggregated bandwidth, e.g., in 5G NR systems and beyond, as well as the various other techniques described herein. The processors 522 may be configured to implement part or all of the features described herein, e.g., by executing program instructions stored on a memory medium (e.g., a non-transitory computer-readable memory medium). Alternatively (or in addition), processor 522 may be configured as a programmable hardware element, such as an FPGA (Field Programmable Gate Array), or as an ASIC (Application Specific Integrated Circuit). Alternatively (or in addition) the processor 522, in conjunction with one or more of the other components 540, 542, 544, 550, 570, 572, 535a-c may be configured to implement part or all of the features described herein.

In addition, as described herein, processors 522 may include one or more processing elements. Thus, processors 522 may include one or more integrated circuits (ICs) that are configured to perform the functions of processors 522. In addition, each integrated circuit may include circuitry (e.g., first circuitry, second circuitry, etc.) configured to perform the functions of processors 522.

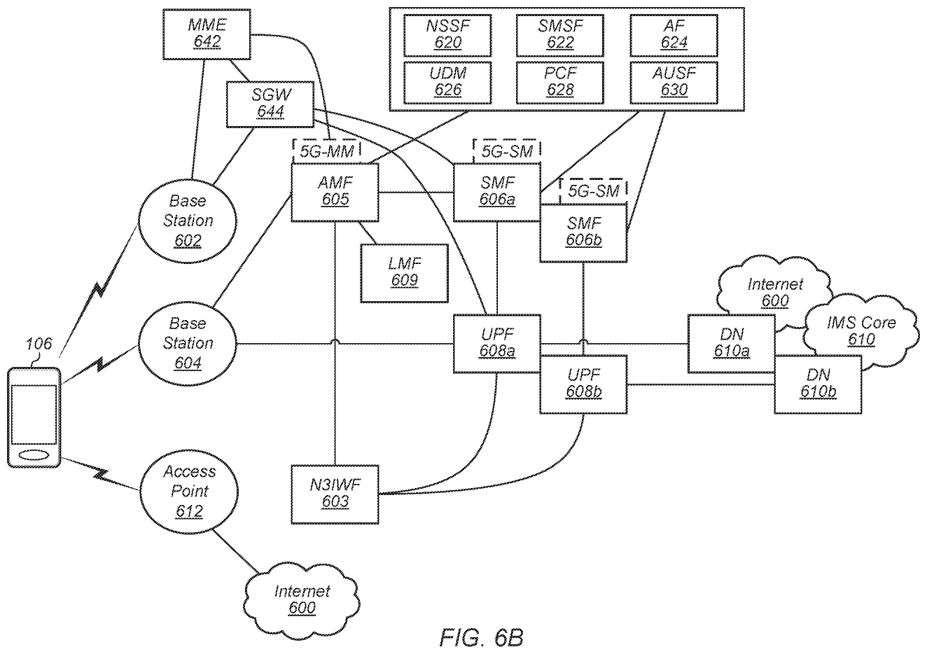

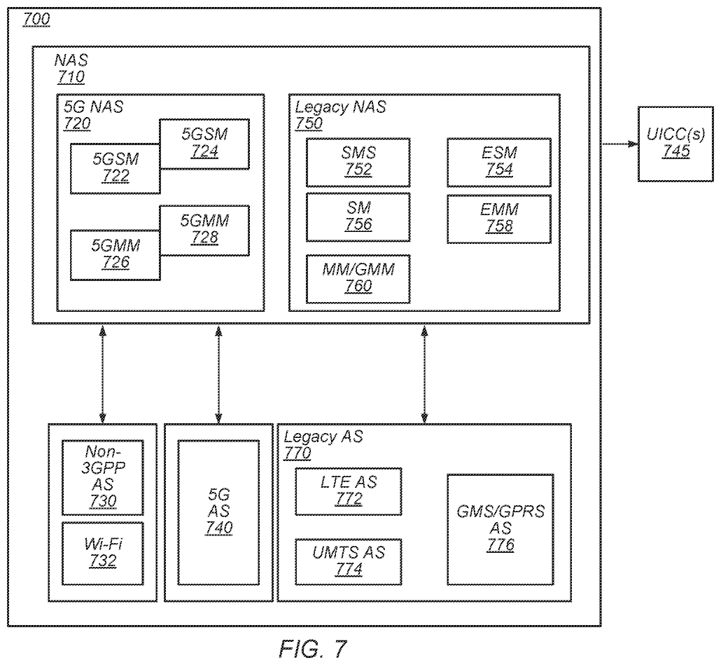

FIGS. 6A, 6B and 7: 5G Core Network Architecture—Interworking with Wi-Fi

In some embodiments, the 5G core network (CN) may be accessed via (or through) a cellular connection/interface (e.g., via a 3GPP communication architecture/protocol) and a non-cellular connection/interface (e.g., a non-3GPP access architecture/protocol such as Wi-Fi connection). FIG. 6A illustrates an example of a 5G network architecture that incorporates both 3GPP (e.g., cellular) and non-3GPP (e.g., non-cellular) access to the 5G CN, according to some embodiments. As shown, a user equipment device (e.g., such as UE 106) may access the 5G CN through both a radio access network (RAN, e.g., such as gNB 604, which may be a base station 102) and an access point, such as AP 612. The AP 612 may include a connection to the Internet 600 as well as a connection to a non-3GPP inter-working function (N3IWF) 603 network entity. The N3IWF may include a connection to a core access and mobility management function (AMF) 605 of the 5G CN. The AMF 605 may include an instance of a 5G mobility management (5G MM) function associated with the UE 106/107. In addition, the RAN (e.g., gNB 604) may also have a connection to the AMF 605. Thus, the 5G CN may support unified authentication over both connections as well as allow simultaneous registration for UE 106/107 access via both gNB 604 and AP 612. As shown, the AMF 605 may be in communication with a location management function (LMF) 609 via a networking interface, such as an NLs interface. The LMF 609 may receive measurements and assistance information from the RAN (e.g., gNB 604) and the UE (e.g., UE 106) via the AMF 605. The LMF 609 may be a server (e.g., server 104) and/or a functional entity executing on a server. Further, based on the measurements and/or assistance information received from the RAN and the UE, the LMF may determine a location of the UE. In addition, the AMF 605 may include one or more functional entities associated with the 5G CN (e.g., network slice selection function (NSSF) 620, short message service function (SMSF) 622, application function (AF) 624, unified data management (UDM) 626, policy control function (PCF) 628, and/or authentication server function (AUSF) 630). Note that these functional entities may also be supported by a session management function (SMF) 606a and an SMF 606b of the 5G CN. The AMF 605 may be connected to (or in communication with) the SMF 606a. Further, the gNB 604 may in communication with (or connected to) a user plane function (UPF) 608a that may also be communication with the SMF 606a. Similarly, the N3IWF 603 may be communicating with a UPF 608b that may also be communicating with the SMF 606b. Both UPFs may be communicating with the data network (e.g., DN 610a and 610b) and/or the Internet 600 and Internet Protocol (IP) Multimedia Subsystem/IP Multimedia Core Network Subsystem (IMS) core network 610.

FIG. 6B illustrates an example of a 5G network architecture that incorporates both dual 3GPP (e.g., LTE and 5G NR) access and non-3GPP access to the 5G CN, according to some embodiments. As shown, a user equipment device (e.g., such as UE 106) may access the 5G CN through both a radio access network (RAN, e.g., such as gNB 604 or eNB 602, which may be a base station 102) and an access point, such as AP 612. The AP 612 may include a connection to the Internet 600 as well as a connection to the N3IWF 603 network entity. The N3IWF may include a connection to the AMF 605 of the 5G CN. The AMF 605 may include an instance of the 5G MM function associated with the UE 106/107. In addition, the RAN (e.g., gNB 604) may also have a connection to the AMF 605. Thus, the 5G CN may support unified authentication over both connections as well as allow simultaneous registration for UE 106/107 access via both gNB 604 and AP 612. In addition, the 5G CN may support dual-registration of the UE on both a legacy network (e.g., LTE via eNB 602) and a 5G network (e.g., via gNB 604). As shown, the eNB 602 may have connections to a mobility management entity (MME) 642 and a serving gateway (SGW) 644. The MME 642 may have connections to both the SGW 644 and the AMF 605. In addition, the SGW 644 may have connections to both the SMF 606a and the UPF 608a. As shown, the AMF 605 may be in communication with an LMF 609 via a networking interface, such as an NLs interface, e.g., as described above, and may include one or more functional entities associated with the 5G CN (e.g., NSSF 620, SMSF 622, AF 624, UDM 626, PCF 628, and/or AUSF 630). Note that UDM 626 may also include a home subscriber server (HSS) function and the PCF may also include a policy and charging rules function (PCRF). Note further that these functional entities may also be supported by the SMF 606a and the SMF 606b of the 5G CN. The AMF 606 may be connected to (or in communication with) the SMF 606a. Further, the gNB 604 may in communication with (or connected to) the UPF 608a that may also be communication with the SMF 606a. Similarly, the N3IWF 603 may be communicating with a UPF 608b that may also be communicating with the SMF 606b. Both UPFs may be communicating with the data network (e.g., DN 610a and 610b) and/or the Internet 600 and IMS core network 610.

Note that in various embodiments, one or more of the above-described network entities may be configured to perform methods for positioning reference signals (PRSs) with aggregated bandwidth, e.g., in 5G NR systems and beyond, e.g., as further described herein.

FIG. 7 illustrates an example of a baseband processor architecture for a UE (e.g., such as UE 106), according to some embodiments. The baseband processor architecture 700 described in FIG. 7 may be implemented on one or more radios (e.g., radios 429 and/or 430 described above) or modems (e.g., modems 510 and/or 520) as described above. As shown, the non-access stratum (NAS) 710 may include a 5G NAS 720 and a legacy NAS 750. The legacy NAS 750 may include a communication connection with a legacy access stratum (AS) 770. The 5G NAS 720 may include communication connections with both a 5G AS 740 and a non-3GPP AS 730 and Wi-Fi AS 732. The 5G NAS 720 may include functional entities associated with both access stratums. Thus, the 5G NAS 720 may include multiple 5G MM entities 726 and 728 and 5G session management (SM) entities 722 and 724. The legacy NAS 750 may include functional entities such as short message service (SMS) entity 752, evolved packet system (EPS) session management (ESM) entity 754, session management (SM) entity 756, EPS mobility management (EMM) entity 758, and mobility management (MM)/GPRS mobility management (GMM) entity 760. In addition, the legacy AS 770 may include functional entities such as LTE AS 772, UMTS AS 774, and/or GSM/GPRS AS 776.

Thus, the baseband processor architecture 700 allows for a common 5G-NAS for both 5G cellular and non-cellular (e.g., non-3GPP access). Note that as shown, the 5G MM may maintain individual connection management and registration management state machines for each connection. Additionally, a device (e.g., UE 106) may register to a single PLMN (e.g., 5G CN) using 5G cellular access as well as non-cellular access. Further, it may be possible for the device to be in a connected state in one access and an idle state in another access and vice versa. Finally, there may be common 5G-MM procedures (e.g., registration, de-registration, identification, authentication, as so forth) for both accesses.

Note that in various embodiments, one or more of the above-described functional entities of the 5G NAS and/or 5G AS may be configured to perform methods for positioning reference signals (PRSs) with aggregated bandwidth, e.g., in 5G NR systems and beyond, e.g., as further described herein.

### Bandwidth Aggregation for Positioning Reference Signals

Modem cellular communications systems, such as those defined by 3GPP standards, may benefit from knowledge of the physical location of the UE. Signaling between a UE and one or more base stations may be used to determine the UE's location. For example, a positioning reference signal (PRS) may be transmitted by a base station, such as the BS 102, and received by a UE, such as the UE 106, for use in Observed Time Difference of Arrival (OTDOA) measurements, to determine distance between the base station and the UE. Accuracy in such measurements may be increased by increasing the bandwidth of the PRS. In NR Release 17, the maximum bandwidth for PRS is one downlink (DL) positioning frequency layer (PFL), which may include up to 272 PRS resources, organized as one or more PRS resource sets. A UE supporting multiple positioning frequency layers is expected to process only one frequency layer at a time. However, greater accuracy may be desired than can be achieved with a single PFL of this size.

A 3GPP Release 17 study item on New Radio (NR) Positioning Enhancements was initiated to study enhancements and solutions necessary to support high accuracy (horizontal and vertical), low latency, network efficiency, and device efficiency requirements for commercial use cases of positioning. Based on this study item, it was concluded that aggregation of NR PFLs improves positioning accuracy under certain scenarios, configurations, and assumptions on modeled impairments such as bandwidth and spacing of aggregated layers, timing offset and frequency offset over frequency layers, and phase discontinuity and possible amplitude imbalance. Further, regarding aggregation of DL PRS resources, the study item concluded, among other conclusions, that further study could be conducted on simultaneous transmission by a base station and reception by a UE of intra-band one or more contiguous carriers in one or more contiguous PFLs. In addition, regarding aggregation of uplink (UL) sounding reference signal (SRS) for positioning resources, the study item concluded, among other conclusions, that further study could be conducted on simultaneous transmission by a UE and aggregated reception by a base station of the SRS for positioning in multiple contiguous intra-band carriers.

In particular, it has been determined that there is a need to:
(1) specify bandwidth aggregation for positioning measurements across up to three intra-band contiguous carriers;
(2) specify signaling and procedures to support aggregation of PRS/SRS (respectively) resources across PFLs/carriers (respectively) for positioning measurements under the assumption that the signals over aggregated resources are transmitted and received (respectively) using a single RF chain (e.g., same antenna) at the base station; and
(3) specify radio resource measurement (RRM) requirements with measurement gaps in connected mode and in inactive mode, including PRS measurement period/reporting. Within the scope of this context, support of bandwidth aggregation for positioning measurements may apply only to timing related measurements (e.g., such as reference signal time difference [RSTD], relative time of arrival [RTOA], and UE/base station Rx-Tx time difference).

Unresolved issues remain, however, including: how to handle contiguous/noncontiguous PRSs within the intra-band contiguous carriers, and how synchronization signal block (SSB) prioritization will be handled in these scenarios; how to reduce power imbalance between component carriers (CCs) in the context of PRS bandwidth aggregation; how measurements relevant to PRS procedures are modified to account for bandwidth aggregation; and how to update measurement gap (MG) and assistance information to accommodate bandwidth aggregation.

Embodiments described herein provide systems, methods, and mechanisms for configuration and control for PRS bandwidth aggregation for DL positioning, including systems, methods, and mechanisms for addressing the unresolved issues outlined above.

### Joint and Independent Processing

With the assumption that PRS aggregation is performed across a plurality of (e.g., three) intra-band contiguous carriers, the aggregated PRS resources from those carriers should be contiguous.

Traditionally, the SSB is given priority over PRS. Specifically, DL PRS resources are not transmitted on SSB. Therefore, the UE assumes that the DL PRS from the serving cell is not mapped to any symbol that contains a SS/PBCH block from the serving cell. Similarly, if the time frequency location of the SS/PBCH block transmissions from non-serving cells are provided to the UE, then the UE also assumes that the DL PRS from a non-serving cell is not mapped to any symbol that contains the SS/PBCH block of the same non-serving cell. However, in the context of PRS aggregation, this assumption can lead to interruption of contiguous aggregated PRS resources.

The question then arises as to how the UE should handle such possible disruptions, e.g., due to higher-priority signaling, such as SSB.

In some implementations, when PRS aggregation is used, the UE may be constrained to always jointly receive and process the aggregated PRS resources across the multiple carriers. To enable this, some implementations may reverse the traditional rule, to treat multi-carrier PRS as the highest-priority signal. Thus, multi-carrier PRS is always received on all of the aggregated carriers. Alternatively, SSB (and/or other signal) may continue to be treated as a higher-priority signal, which may preempt PRS transmission on one or more of the contiguous carriers. In such implementations, the PRS may be received/processed based on relative signal priorities. For example, if any of the configured PRS resources are not received/processed, due to preemption by a higher priority signal, then the UE may forego processing all of the aggregated PRS resources, as the UE may be unable to jointly process the entire set of aggregated PRS resources.

In other implementations, the UE may be configured to disjointly, or independently, receive and process PRS resources on a subset of the contiguous carriers. This allows the UE to receive and process PRS resources based on relative signal priorities (e.g., with SSB or other high-priority signals preempting PRS resources on one or more of the contiguous carriers), while still utilizing the PRS resources that are successfully received. As a first example of such disjoint processing, in some implementations, if any of the configured PRS resources are not received/processed due to preemption by a higher priority signal, then the other PRS resources may still be independently received and processed. The UE may transmit to the base station dynamic signaling indicating which of the PRS resources are received and processed. Such signaling may be per-CC signaling (e.g., express signaling within each CC to provide feedback for that CC), or may include signaling for a single CC, with a cross-CC indication (e.g., signaling within a single CC, which may indicate that the signaling applies to additional CCs), or may utilize other formats.

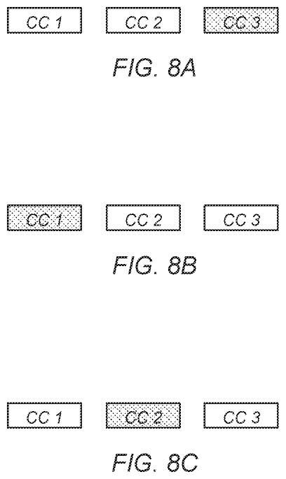

As a second example of disjoint handling of aggregated PRS resources, the UE may be constrained to disjointly process only contiguous PRS resources. Specifically, if any of the configured PRS resources are not received/processed due to preemption, then any PRS that results in a non-contiguous overall transmission may not be received, while PRS resources received in any two or more contiguous CCs may be received and processed. This is illustrated in FIGS. 8A-C. As in the first example of disjoint handling of aggregated PRS resources, the UE may provide signaling to indicate which of the PRS resources were received and processed.

FIG. 8A illustrates a scenario in which three CCs (CC1, CC2, and CC3) are configured to carry aggregated PRS resources. However, PRS resources are not received for CC3, e.g., due to preemption by a higher-priority signal, such as SSB. In this scenario, PRS resources are received for CC1 and CC2. If the receiving UE is constrained to jointly process the PRS resources, then PRS reception may fail in this scenario for all three CCs, because the PRS resources of CC3 were not received. If the UE instead operates according to the first example of disjoint processing, then the PRS resources received for CC1 and CC2 may be independently received and processed, despite the failure to receive the PRS resources for CC3. If the UE operates according to the second example of disjoint processing, then the PRS resources received for CC1 and CC2 may be independently received and processed, despite the failure to receive the PRS resources for CC3, because CC1 and CC2 are contiguous.

FIG. 8B illustrates a similar scenario in which the three CCs are configured to carry aggregated PRS resources, but in which PRS resources are not received for CC1, e.g., due to preemption by a higher-priority signal, such as SSB. In this scenario, PRS resources are received for CC2 and CC3. If the receiving UE is constrained to jointly process the PRS resources, then PRS reception may fail in this scenario for all three CCs, because the PRS resources of CC1 were not received. If the UE instead operates according to the first example of disjoint processing, then the PRS resources received for CC2 and CC3 may be independently received and processed, despite the failure to receive the PRS resources for CC1. If the UE operates according to the second example of disjoint processing, then the PRS resources received for CC2 and CC3 may be independently received and processed, despite the failure to receive the PRS resources for CC, because CC2 and CC3 are contiguous.

FIG. 8C illustrates a similar scenario in which the three CCs are configured to carry aggregated PRS resources, but PRS resources are not received for CC2, e.g., due to preemption by a higher-priority signal, such as SSB. In this scenario, PRS resources are received for CC1 and CC3. If the receiving UE is constrained to jointly process the PRS resources, then PRS reception may fail in this scenario for all three CCs, because the PRS resources of CC2 were not received. If the UE instead operates according to the first example of disjoint processing, then the PRS resources received for CC1 and CC3 may be independently received and processed, despite the failure to receive the PRS resources for CC2, as the PRS resources of each CC are received and processed independently. If the UE operates according to the second example of disjoint processing, then the PRS resources received for CC1 and CC3 may not be independently received and processed, because CC1 and CC3 are not contiguous. In some implementations, the UE may provide to the base station an indication of UE capability in connection with support for joint and/or independent processing of aggregated PRS resources across contiguous CCs. For example, the UE may indicate that it supports a certain capability set. As a first example, the UE may indicate that it supports joint processing of contiguous PRS resources only. As a second example, the UE may indicate that it supports joint processing of non-contiguous PRS resources. As a third example, the UE may indicate that it supports independent processing of contiguous and/or non-contiguous PRS resources. Upon receiving the indication of the third example, the base station may switch dynamically between sending joint information, if the PRS resources are contiguous, and sending independent information, if the PRS resources are not contiguous.

### Power Imbalance

As noted above, the base station may be constrained to a single RF chain when aggregating bandwidth across multiple PFLs. This may assist in avoiding timing mismatch between CCs transmitted via different RF chains. However, a UE may receive aggregated PRS resources using multiple RF chains or different beams (transmission configuration indicator [TCI] states), which may result in power imbalance between CCs. Such a power imbalance will lead to poor performance in determining a timing estimate for the aggregated channel. To mitigate the power imbalance, the UE may indicate that it does not expect a different TCI state across different PFLs when PFL aggregation is used. Otherwise, a mechanism to resolve the power imbalance may need to be applied.

To reduce the power imbalance between CCs, the UE may feed back information regarding the imbalance to the base station. For example, the UE may transmit on each CC the PRS Reference Signal Received Power (RSRP) for that CC. In some scenarios, the UE may feed back the PRS-RSRP in a positioning feedback field on the LTE Positioning Protocol (LPP). This would require the addition of PRS-RSRP per CC for all positioning methods. In some scenarios, the UE may feed back the PRS-RSRP in PRS assistance data, such as the NR-PRS-BW-aggregation-assistance-data sent from UE to LMF, e.g., via the base station.

In response to receiving the feedback from the UE, the base station may perform transmit power adjustment on the PRS, to reduce the power imbalance and equalize power between CCs. For example, the base station may use one or more of the following parameters to adjust PRS power. A PowerControlOffset parameter may be an integer of value {−8 to 15} dB, and may represent a power offset applied to the PRS resource element (RE), relative to the PDSCH RE. A PowerControlOffsetSS parameter may be an integer or enumerated value in dB, and may represent a power offset applied to the PRS RE, relative to the secondary synchronization signal (SSS) RE.

In some scenarios, the base station may configure transmit power adjustment for the PRS during RRC configuration, e.g., as part of the initial setup. In some scenarios, the base station may configure transmit power adjustment for the PRS in a MAC-CE. E.g., the base station may use the MAC-CE to trigger a specific offset for the PRS. The MAC-CE may indicate a specific value or may provide a set of values for later selection. In some scenarios, the base station may configure transmit power adjustment for the PRS in a DCI. For example, the base station may use the DCI to indicate a specific value, or to select a single value from a set of values provided in the MAC-CE. As another example, the base station may use the DCI to indicate an up- or down-modifier, indicating that the power offset should be increased or decreased.

### Adjusting Measurements to Accommodate PRS Aggregation

Various measurements may be modified to account for bandwidth aggregation of the PRS. Some measurements may continue to occur for each CC. Some measurements may occur jointly across CCs. In the latter case, the measurements are tied to multiple aggregated resources, resource sets, or frequency layers. This may be done by applying a concept of PFL groups, where multiple PFLs are grouped together.

As one example, PRS RSRP measurements may be reported by the UE for each CC in a set of CCs across which PRS aggregation has been configured. Such measurements may be used, e.g., as power imbalance feedback.

Alternatively, or additionally, PRS RSRP measurements may be reported jointly over all of the CC. Such joint measurements may be used, e.g., for positioning estimation. As one example, such joint measurements may be defined as follows.

When bandwidth aggregation is enabled, the UE may be configured to measure and report, subject to UE capability, a plurality (e.g., up to 24×Ni) of DL PRS-RSRP measurements on DL PRS resources of the same PRS; e.g., associated with the same dl-PRS-ID {per CC feedback}. In addition, the UE may be configured to measure and report, subject to UE capability, a plurality (e.g., up to 24{or 24x 3}) of DL PRS-RSRP measurements on DL PRS resources associated with the same dl-PRS-IDs, associated with a resource set group (e.g., an aggregated plurality of PRS resource sets) {all CC feedback}. When the UE reports DL PRS-RSRP measurements from one DL PRS resource set group, the UE may indicate which DL PRS-RSRP measurements associated with the same higher layer parameters nr-DL-PRS-RxBeamIndex [17, TS 37.355] have been performed using the same spatial domain filter for reception if for each nr-DL-PRS-RxBeamIndex reported there are at least 2 DL PRS-RSRP measurements associated with it within the DL PRS resource set for each set in the DL PRS resource set group. When the UE reports DL PRS-RSRP measurements for a DL PRS resource, the reported multiple DL PRS-RSRP measurements associated with the same or different higher layer parameter nr-DL-PRS-RxBeamIndex may have the same or different timestamps.

Similar adjustments may be made for measuring Reference Signal Received Path Power (RSRPP). The UE may be configured to measure, and optionally report, subject to UE capability, up to 24 DL PRS-RSRPP for the first detected path on DL PRS resources associated with the same dl-PRS-IDs associated with the DL PRS resource set group.

Measurement of UE Rx-Tx time difference may also be adjusted. The UE may be configured to measure and report, subject to UE capability, up to 4 UE Rx-Tx time difference measurements corresponding to a single resource set or resource set group for positioning. Each measurement may correspond to a single received DL PRS resource set or resource set group, which can be in different DL PRS PFL groups.

DL PRS resource reference may also be adjusted to accommodate PRS aggregation. The network may indicate to the UE that DL PRS resources can be used as the reference for the DL RSTD, DL PRS-RSRP, DL PRS-RSRPP, and UE Rx-Tx time difference measurements in a higher layer parameter nr-DL-PRS-ReferenceInfo. The reference indicated by the network to the UE can also be used by the UE to determine how to apply higher layer parameters nr-DL-PRS-ExpectedRSTD and nr-DL-PRS-ExpectedRSTD-Uncertainty. The UE may expect the reference to be indicated whenever it is expected to receive the DL PRS. This reference provided by nr-DL-PRS-ReferenceInfo may include a dl-PRS-ID, a DL PRS resource set ID, and optionally a single DL PRS resource ID or a list of DL PRS resource IDs. For bandwidth aggregation, this reference provided by nr-DL-PRS-ReferenceInfo may include {option1} a dl-PRS-ID or {option 2} a set of dl-PRS-IDs associated with a resource group; {option1} a DL PRS resource set group ID or {option2} a set of DL PRS resource set IDs associated with a DL PRS resource set group; and optionally a single DL PRS resource ID or a list of DL PRS resource IDs associated with multiple DL PRS resource groups.

NR-DL-TDoA measurements may also be adjusted to accommodate PRS aggregation. For DL UE positioning measurement reporting in higher layer parameters NR-DL-TDOA-SignalMeasurementInformation or NR-Multi-RTT-SignalMeasurementInformation with bandwidth aggregation the UE can be configured to report the DL PRS resource ID(s) or the DL PRS resource set ID(s) associated with the DL PRS resource(s) in DL PRS resource groups or the DL PRS resource set(s) in DL PRS resource set groups which are used in determining the UE measurements DL RSTD, or UE Rx-Tx time difference, respectively.

DL RSTD measurements may also be adjusted to accommodate PRS aggregation. UE may be configured to measure and report, subject to UE capability, up to 4 DL RSTD measurements per pair of dl-PRS-IDs associated with a PRS resource group with each measurement between a different pair of DL PRS resources associated with a PRS resource group or DL PRS resource sets associated with a PRS resource set group within the DL PRS configured for those dl-PRS-IDs. If the UE is not configured to report with multiMeasInSameReport-r17, the up to 4 measurements being performed on the same pair of dl-PRS-IDs associated with a PRS resource group and all DL RSTD measurements in the same report may use a single reference timing. If the UE is configured to report with multiMeasInSameReport-r17, the up to 4 measurements being performed on the same pair of dl-PRS-IDs associated with a PRS resource group and all DL RSTD measurements in the same measurement instance of the same report may use a single reference timing.

### Measurement Gap Adjustment

A UE may receive PRSs from multiple base stations. The UE may be configured with a measurement gap (MG), during which its primary base station should not transmit, to allow the UE an opportunity to perform measurements on neighbor base stations. The PRS processing window (PPW) provides a similar opportunity for the UE to receive a PRS, outside of the MG. The MG is configured with an MG period, specifying how often an MG occurs, as well as an MG length, specifying the length of time during which the MG occurs at the start of the MG period. Because the UE has traditionally been expected to handle only one PFL at a time, current MG configurations are adapted to accommodate reception of one PFL. However, with aggregation of multiple (e.g., two, three, or more) PFLs, the existing measurement gap may not be large enough.

Presently, the largest MG patterns available within 3GPP specifications define a MG length of 20 ms with a MG period of 160 ms, or a MG length of 10 ms with a MG period of 80 ms. PRS aggregation may introduce a need for larger MG lengths, possibly in conjunction with adjusted MG periods. It may be noted that such adjustments may also be useful for other methods used to increase accuracy, such as Carrier Phase Positioning.

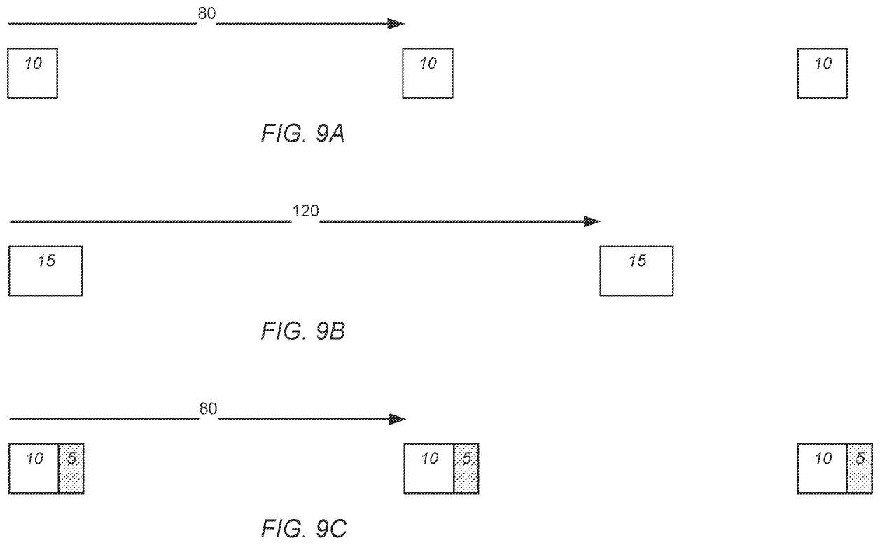

FIGS. 9A-C illustrate possible adaptations of MGs for use with PRS aggregation.

In some implementations, the MG parameters may not be changed when PRS aggregation is in use. This is illustrated in FIG. 9A. As illustrated, the UE is configured with a MG length of 10 ms with a MG period of 80 ms. Any other existing MG parameters may be used in other scenarios.

In some implementations, the base station may configure the UE with new MG parameters in response to configuring PRS aggregation. This is illustrated in FIG. 9B. As illustrated, the UE is configured with an MG length of 15 ms and an MG period of 120 ms. Other parameters may also be available to accommodate PRS aggregation, such as MG length of 10 ms and MG period of 80 ms, MG length of 15 ms and MG period of 120 ms, MG length of 20 ms and MG period of 160 ms, MG length of 25 ms and MG period of 200 ms, MG length of 30 ms and MG period of 240 ms, or others.

In some implementations, the base station may configure the UE with a delta value, representing a time value by which the signaled MG length may be increased during PRS aggregation. This is illustrated in FIG. 9C. As illustrated, the UE is configured with an MG length of 10 ms and an MG period of 80 ms, as in FIG. 9A, but in FIG. 9C the UE is further configured with a delta value of 5 ms. The MG may be increased by the delta value, resulting in a total MG of 15 ms, repeated every 80 ms. Other values may be used for the delta value.

Such options may, in some implementations, be defined as a feature group, e.g., as follows:
Features: NR Positioning Support
   Feature Group: Additional measurement gap patterns for PRS measurements with CPP Components:
      Option 2: New parameters

$$MG pattern with MGL = 10 ms , \\ MGRP = 80 ms for PRS measurements \qquad ( 1 )$$

$$MG pattern with MGL = 15 ms , \\ MGRP = 120 ms for PRS measurements \qquad ( 2 )$$

$$MG pattern with MGL = 20 ms , \\ MGRP = 160 ms for PRS measurements \qquad ( 3 )$$

Option 3: Pattern and periodicity are based on legacy, delta1 adds extra time

$$MG pattern with MGL = 10 ms + Delta 1 , \\ MGRP = 80 ms for PRS measurements \qquad ( 1 )$$

$$MG pattern with MGL = 15 ms + Delta 1 , \\ MGRP = 160 ms for PRS measurements \qquad ( 2 )$$

RAN1 feature list: 13-x Common DL PRS Processing Capability+CPP
Field Name in 38.331: RRC supportedGapPattern-rxx
Parent IE in 38.331: RRC MeasAndMobParametersCommon
Note: New MG patterns are applicable for PRS and NR/LTE RRM measurements i.e. new gaps are not shared between PRS and 2G/3G RRM measurements.
The new measurement gap patterns can be requested by the UE for FDD and TDD NR positioning measurements.
The new measurement gap patterns can be requested by the UE and configured by the network only when the UE is configured via LPP with NR positioning measurements requiring such gaps and can only be used during the corresponding positioning measurement period.
NOTE: may be applicable to PRS aggregation scenario with UE measuring multiple PRSs in multiple PFLs simultaneously.

In some implementations, MG parameters may be modified to accommodate PRS aggregation by increasing the MG length, and possibly the MG period, by a scaling factor x, where 1<x<Ni. In some implementations, the base station may implement this scaling by configuring a scaled length for measurement across all CCs. In other implementations, the base station may implement this scaling by configuring a MG length, e.g., according to existing options, and then increasing the MG based on the number of CCs.

Implementing such changes may benefit from increasing the size and/or number of parameters for gap pattern configuration. For example, the MG configuration may be updated to maxFreqLayerGroups, as follows:

NR-PRS-MeasurementInfoList-rxx ::= SEQUENCE (SIZE
(1..maxFreqLayersGrpups)) OF NR-PRS-MeasurementInfo-rxx

The length of MG configuration may also be increased, e.g., as follows:

| | |
|---|---|
| NR-PRS-MeasurementInfo-r16 ::= | SEQUENCE { |
| dl-PRS-PointA-r16 | ARFCN-ValueNR, |

nr-MeasPRS-RepetitionAndOffset-r16 CHOICE {

| | |
|---|---|
| ms20-r16 | INTEGER (0..19), |
| ms40-r16 | INTEGER (0..39), |
| ms80-r16 | INTEGER (0..79), |
| ms160-r16 | INTEGER (0..159), |

```
    ...
  },
```

| | |
|---|---|
| nr-MeasPRS-length-r16 | ENUMERATED {ms1dot5, |

ms3, ms3dot5, ms4, ms5dot5, ms6, ms10, ms20, ms4dot5, ms9, ms7, ms
10dot5, ms11, ms16dot5, ms12, ms18, ms 30, ms40, ms60},
...
}

Traditionally, UE capabilities for DL PRS measurement outside MG and in a PRS processing window (PPW) is defined per band. If the UE indicates capability to aggregate PFLs across multiple bands. then UE capabilities for DL PRS measurement outside MG and in a PPW may be defined per band combination or per band of band combinations.

### Assistance Information

Assistance information may be provided by the UE to report impairments introduced into system performance as a result of aggregation of multiple PFLs. For example, the UE may indicate to positioning intelligence some measure of impairments introduced by the aggregation. In some instances, the UE may feed back a quality metric, e.g., as part of the positioning feedback, or as part of the feedback assistance.

In response to any assistance information regarding the aggregated PRS, the network may take action to either: disable bandwidth aggregation, correct the impairment, or compensate for the impairment in the local estimate.

An example of information to be fed back may include RSRP, fed back per CC, for use in determining power imbalance. In response to such feedback, the network may modify the transmit power of the PRS.

Another example of information to be fed back is a timing offset, such as Timing Advance Error (TAE), fed back per CC, or a diming difference between CCs. In response to such feedback, the base station may send a timing correction to the UE.

Other examples may include a frequency offset error, fed back per CC, or a phase offset error estimate.

### Timing Error Groups Adjustment

At the UE, a Rx Timing Error Group (TEG) is associated with one or more DL measurements that have an Rx timing error difference within a certain margin. A UE RxTx TEG is associated with one or more UE Rx-Tx time difference measurements that have the “Rx timing errors+Tx timing errors” difference within a certain margin. Such TEGs may be adjusted to accommodate PRS aggregation.

The functional definition of such TEGs may be defined for use with PRS aggregation as follows:

UE is configured to report UE Rx TEG and/or UE RxTx TEG for all measurements in all CCs, e.g., as assistance information. UE is configured to report difference between UE Rx TEG and/or UE RxTx TEG for all measurements in all CCs. UE sends flag if difference of UE Rx TEG and/or UE RxTx TEG is greater than a configured or specified value. If use only 1 DL PRS resource across CCs, UE still reports parameters for each CC. If the UE reports a UE RxTx TEG ID with a UE Rx-Tx time difference measurement, the UE may report a UE RxTx TEG timing error margin value for each CC, via high layer parameter nr-UE-RxTxTEG-TimingErrorMargin, for all the UE RxTx TEGs within one NR-Multi-RTT-SignalMeasurementInformation. The UE may be provided with association information of DL PRS resource(s) with Tx TEGs via higher layer parameter dl-prs-trp-Tx-TEG-ID for a dl-PRS-ID. For PRS aggregation, multiple resources may be mapped to a single TxTEG or a single resource may be mapped to multiple Tx TEGs. The UE may report a one or more UE Rx TEG IDs via higher layer parameter nr-UE-Rx-TEG-ID for a RSTD reference time dl-PRS-ReferenceInfo and a one or more UE Rx TEG IDs for each DL RSTD measurement, where the DL RSTD can be DL RSTD measurement in NR-DL-TDOA-MeasElement and/or NR-DL-TDOA-AdditionalMeasurementElement.

### Example Scenarios

A method for reducing power imbalance between a plurality of component carriers (CCs) carrying a positioning reference signal (PRS) may include a UE receiving, from a base station, a plurality of PRS resources across the plurality of CCs; determining a first reference signal receive power (RSRP) measurement of the PRS resources of a first CC of the plurality of CCs; determining a second reference signal receive power (RSRP) measurement of the PRS resources of a second CC of the plurality of CCs; and reporting the first RSRP measurement and the second RSRP measurement to the base station.

In some scenarios, the first RSRP measurement may be provided via a positioning feedback field of the LTE Positioning Protocol (LPP).

In some scenarios, the first RSRP measurement may be included in PRS assistance data provided to the base station.

In some scenarios, the method may further include the UE determining a third RSRP measurement of the PRS resources of all CCs of the plurality of CCs; and reporting the third RSRP measurement to the base station.

A method for adjusting measurement parameters to accommodate positioning reference signal (PRS) bandwidth aggregation may include a UE receiving, from a primary base station, an indication of a measurement gap (MG) length and a MG period; increasing the MG length in response to determining that PRS bandwidth aggregation is configured for the UE; and receiving a PRS from a neighbor cell within the increased MG.

In some scenarios, increasing the MG length may include increasing the MG length by a time value received from the primary base station.

In some scenarios, increasing the MG length may include scaling the MG length by a factor based on a number of component carriers included in the aggregated bandwidth.

A method for performing position reference signal (PRS) communications may include a UE receiving, from a base station, configuration information indicating that a PRS communication will include PRS resources aggregated from a plurality of component carriers (CCs); receiving PRS resources within the plurality of CCs; foregoing processing of the PRS communication in response to determining that configured PRS resources of a first CC of the plurality of CCs were not received; and reporting to the base station that the PRS communication was not processed.

In some scenarios, the foregoing processing of the PRS communication is further in response to determining that the received PRS resources are not contiguous because of the absence of the configured PRS resources of the first CC.

In some scenarios, the method may further include providing to the base station an indication that a user equipment (UE) supports joint processing of contiguous PRS only.

A method for performing position reference signal (PRS) communications may include receiving, from a base station, configuration information indicating that a PRS communication will include PRS resources aggregated from a plurality of component carriers (CCs); receiving PRS resources within the plurality of CCs; determining that configured PRS resources of a first CC of the plurality of CCs were not received, wherein the received PRS resources are not contiguous because of the absence of the configured PRS resources of the first CC; and processing the received PRS resources as a single PRS communication.

In some scenarios, the method may further include providing to the base station an indication that a user equipment (UE) supports joint processing of non-contiguous PRS.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Embodiments of the present disclosure may be realized in any of various forms. For example, some embodiments may be realized as a computer-implemented method, a computer-readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., a UE 106) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Any of the methods described herein for operating a user equipment (UE) may be the basis of a corresponding method for operating a base station, by interpreting each message/signal X received by the UE in the downlink as message/signal X transmitted by the base station, and each message/signal Y transmitted in the uplink by the UE as a message/signal Y received by the base station.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method, comprising:
determining that bandwidth aggregation is enabled for a plurality of positioning reference signal (PRS) resources across a plurality of positioning frequency layers (PFLs);
receiving, from a base station, the plurality of PRS resources;
determining a first set of reference signal receive power (RSRP) measurements of at least a first subset of the plurality of PRS resources, the first subset including PRS resources from more than one PFL of the plurality of PFLs;
providing, to the base station, on each component carrier (CC) of a plurality of CCs, a report of the first set of RSRP measurements.

2. The method of claim 1, further comprising:
determining a second set of RSRP measurements of a second subset of the plurality of PRS resources, the PRS resources of the second subset belonging to a single PRS resource set;
providing, to the base station, on a single CC of the plurality of CCs, a report of second set of RSRP measurements.

3. The method of claim 1, further comprising:
determining a set of reference signal received path power (RSRPP) measurements for the first detected path of at least a third subset of the plurality of PRS resources, the third subset including PRS resources from more than one PFL of the plurality of PFLs;
providing, to the base station, a report of the set of RSRP measurements.

4. The method of claim 1, further comprising:
determining a set of receive-transmit time difference measurements of at least a third subset of the plurality of PRS resources, the third subset including PRS resources from more than one PFL of the plurality of PFLs;
providing, to the base station, a report of the set of receive-transmit time difference measurements.

5. The method of claim 1, wherein each CC of the plurality of CCs contains a subset of the plurality of PRS resources.

6. The method of claim 1, wherein the PRS resources have a higher priority level than a synchronization signal block (SSB).

7. The method of claim 1, wherein the PRS resources are non-contiguous.

8. An apparatus, comprising:
processing circuitry configured to cause the apparatus to:
determine that bandwidth aggregation is enabled for a plurality of positioning reference signal (PRS) resources across a plurality of positioning frequency layers (PFLs);
receive, from a base station, the plurality of PRS resources;
determine a first set of reference signal receive power (RSRP) measurements of at least a first subset of the plurality of PRS resources, the first subset including PRS resources from more than one PFL of the plurality of PFLs;
provide, for transmission to the base station on each component carrier (CC) of a plurality of CCs, a report of the first set of RSRP measurements.

9. The apparatus of claim 8, wherein the processing circuitry is configured to cause the apparatus to:
determine a second set of RSRP measurements of a second subset of the plurality of PRS resources, the PRS resources of the second subset belonging to a single PRS resource set;
provide, to the base station, on a single CC of the plurality of CCs, a report of second set of RSRP measurements.

10. The apparatus of claim 8, wherein the processing circuitry is configured to cause the apparatus to:
determine a set of reference signal received path power (RSRPP) measurements for the first detected path of at least a third subset of the plurality of PRS resources, the third subset including PRS resources from more than one PFL of the plurality of PFLs;
provide, to the base station, a report of the set of RSRP measurements.

11. The apparatus of claim 8, wherein the processing circuitry is configured to cause the apparatus to:
determine a set of receive-transmit time difference measurements of at least a third subset of the plurality of PRS resources, the third subset including PRS resources from more than one PFL of the plurality of PFLs;
provide, to the base station, a report of the set of receive-transmit time difference measurements.

12. The apparatus of claim 8, wherein each CC of the plurality of CCs contains a subset of the plurality of PRS resources.

13. The apparatus of claim 8, wherein the PRS resources have a higher priority level than a synchronization signal block (SSB).

14. The apparatus of claim 8, wherein the PRS resources are non-contiguous.

15. A non-transitory computer-readable memory medium storing instructions executable by a processor of a user equipment (UE) to cause the UE to:
determine that bandwidth aggregation is enabled for a plurality of positioning reference signal (PRS) resources across a plurality of positioning frequency layers (PFLs);
receive, from a base station, the plurality of PRS resources;
determine a first set of reference signal receive power (RSRP) measurements of at least a first subset of the plurality of PRS resources, the first subset including PRS resources from more than one PFL of the plurality of PFLs;
provide, for transmission to the base station on each component carrier (CC) of a plurality of CCs, a report of the first set of RSRP measurements.

16. The non-transitory computer-readable memory medium of claim 15, wherein the instructions are further executable to cause the UE to:
determine a second set of RSRP measurements of a second subset of the plurality of PRS resources, the PRS resources of the second subset belonging to a single PRS resource set;
provide, to the base station, on a single CC of the plurality of CCs, a report of second set of RSRP measurements.

17. The non-transitory computer-readable memory medium of claim 15, wherein the instructions are further executable to cause the UE to:
determine a set of reference signal received path power (RSRPP) measurements for the first detected path of at least a third subset of the plurality of PRS resources, the third subset including PRS resources from more than one PFL of the plurality of PFLs;
provide, to the base station, a report of the set of RSRP measurements.

18. The non-transitory computer-readable memory medium of claim 15, wherein the instructions are further executable to cause the UE to:
determine a set of receive-transmit time difference measurements of at least a third subset of the plurality of PRS resources, the third subset including PRS resources from more than one PFL of the plurality of PFLs;
provide, to the base station, a report of the set of receive-transmit time difference measurements.

19. The non-transitory computer-readable memory medium of claim 15, wherein each CC of the plurality of CCs contains a subset of the plurality of PRS resources.

20. The non-transitory computer-readable memory medium of claim 15, wherein the PRS resources have a higher priority level than a synchronization signal block (SSB).
